(19) United States
(12) Patent Application Publication
(10) Pub. No.: US 2022/0147413 A1
(43) Pub. Date: May 12, 2022

(54) COMPLIANCE MONITOR FOR OPERATIONAL SOFTWARE SYSTEMS

(71) Applicant: International Business Machines Corporation, Armonk, NY (US)

(72) Inventors: Manus Kevin McHugh, Colorado Springs, CO (US); KIRK M. WOODS, Lathrop, MO (US); Schuyler Bruce Matthews, Cary, NC (US); Jeremy R. Fox, Georgetown, TX (US)

(21) Appl. No.: 17/093,125

(22) Filed: Nov. 9, 2020

(51) Int. Cl. G06F 11/07; G06F 11/36

(52) U.S. Cl. CPC G06F 11/0793; G06F 11/0775; G06F 11/0751; G06F 11/3612

(57) ABSTRACT

In an approach to monitoring production software to detect design deviations, one or more actionable elements of a software design are received, where the one or more actionable elements are one or more allowable actions of the software design. One or more actions performed by one or more instances of an instrumented software application are monitored, where the one or more instances of an instrumented software application are based on the software design. The one or more actions are compared to the one or more actionable elements. A non-compliant behavior is detected, where the non-compliant behavior is a sequence of the one or more actions performed by any instance of the one or more instances of the instrumented software application that deviates from the one or more actionable elements.

### BACKGROUND

The present invention relates generally to the field of software management, and more particularly to monitoring production software to detect design deviations.

Software verification and validation is an important function whereby the software developers and testers attempt to ensure the accurate development of the product throughout the development life cycle. Both software verification and validation help create a software product that efficiently meets the specified requirements of the customer and offers them optimum services.

Verification is the process of checking or verifying the credentials, data, or information to confirm their credibility and accuracy. In the field of software engineering, software verification is defined as the process of evaluating the software product to ensure that the development phase is being carried out to accurately build the desired software product. It is performed throughout the software development phase, to ensure the detection of defects and faults in the early stage of the development life cycle.

### SUMMARY

Embodiments of the present invention disclose a method, a computer program product, and a system for monitoring production software to detect design deviations. In one embodiment, one or more actionable elements of a software design are received, where the one or more actionable elements are one or more allowable actions of the software design. One or more actions performed by one or more instances of an instrumented software application are monitored, where the one or more instances of an instrumented software application are based on the software design. The one or more actions are compared to the one or more actionable elements. A non-compliant behavior is detected, where the non-compliant behavior is a sequence of the one or more actions performed by any instance of the one or more instances of the instrumented software application that deviates from the one or more actionable elements.

### BRIEF DESCRIPTION OF THE DRAWINGS

FIG. 1 is a functional block diagram illustrating a distributed data processing environment, in accordance with an embodiment of the present invention.

FIG. 2 is an example of the basic functionality of the present invention, in accordance with an embodiment of the present invention.

FIG. 3 is an example of a detail view illustrating the steps for monitoring production software to detect design deviations, in accordance with an embodiment of the present invention.

FIG. 4 is a flowchart depicting operational steps for the monitoring program, on a computing device within the distributed data processing environment of FIG. 1, for monitoring production software to detect design deviations, in accordance with an embodiment of the present invention.

FIG. 5 depicts a block diagram of components of the computing devices executing the monitoring program within the distributed data processing environment of FIG. 1, in accordance with an embodiment of the present invention.

### DETAILED DESCRIPTION

Currently, software testing is of limited scope and duration. Compliance frameworks such as Automotive SPICE, DO-178C (aircraft), and ISO 26262 call for processes to be executed and audited. But, in the end, these frameworks do not track what the software is actually doing. This means that the effort that goes into “compliance” is really an indirect means to hope that software complies to the design baseline. However, even if the software passes during the verification process, it does not guarantee its validity. It is highly possible that a software product passes the verification process but might fail to achieve the desired requirements.

In an embodiment, the present invention detects software deviation from the normal, using the software design as the baseline. For example, if someone hacks into the software, this causes a different execution path. In an embodiment, the present invention will detect this different execution path. In an embodiment, by combining design with execution, the present invention identifies, in real-time, when software deviates from the design baseline. Further, in an embodiment, the designers can designate known “illegal” or “non-compliant” execution paths. In an embodiment, the present invention easily identifies those. In an embodiment, if the present invention identifies non-compliant execution, then it notifies a human operator and signals the software. Finally, in an embodiment, the present invention tracks the execution paths for later forensic analysis.

In an embodiment, the present invention immediately flags any run-time violations of the design. Specifically, the present invention watches for behaviors, such a sequence of function calls, that are not specifically compliant with the design or a sequence that is explicitly identified as non-compliant. In an embodiment, the present invention provides warnings and remediating actions to operators and software applications for non-compliant behavior.

In various embodiments, examples of non-compliant behaviors include, but are not limited to, the software executes a scenario identified as “forbidden”, the software executes a sequence of calls that is not specified in the model from the design tools, the software enters an “invalid state”, e.g., Class A is in state X and Class B is in state Y, or the software has more than one thread concurrently enter a critical section.

In various embodiments, example responses to non-compliant behavior include, but are not limited to, alerting human oversight of non-compliance, stopping the software in question, diverting the application to a “demo” or “safe” or simulator mode (e.g., security for hacking), or engage a failover mode for a human to take control (e.g., for a self-driving car).

In an embodiment, the present invention provides a way to directly, securely, and in a standard manner detect if multiple, concurrent, operational instances of software are deviating from design specifications.

The present invention is a more generic, open-ended implementation than previous art uses of Unified Modeling Language (UML) run-time frameworks and code generation. In an embodiment, the present invention describes a different, novel implementation that, for instance, uses sequence diagrams as a standard against which to detect fault conditions. These fault conditions may not be apparent to operators or end users.

In an embodiment, the present invention immediately flags any violations of the design. In an embodiment, the present invention watches for behaviors, such as sequences of function calls, that are not specifically compliant in the design or behaviors that are explicitly identified as non-compliant. In an embodiment, the present invention provides warnings and remediating actions to operators and software applications for non-compliant behavior.

In an embodiment, for any given entry point to the software (i.e. main or registered event):

First, the engineer designs and reviews the solution using existing software design tools. The engineer then generates the executable software from the design. The software is instrumented to send messages to the monitor. Software instances are instrumented by combining the Globally Unique Identifiers (GUIDs) provided from the design tool and entered into the software, with well-known techniques, including but not limited to code injection, to signal, for instance, entry or exit of a function. These events are run through a central ‘device’ within that software instance that is responsible to send the event information to the monitor.

The software is then deployed to a run-time environment, while the design sequences from the software design tools are deployed to the monitor. When software instances are deployed and execute, these instances register with the monitor. The monitor initiates a tracking instance of the design unique to each execution instance. The executing software instances send messages to the monitor, which then matches the message to the proper instance and progresses the design instance status against the design sequences from the software design tools based on the message from the software instance. Next, if the monitor observes an invalid sequence, the monitor will change the status of the instance to an error status. In various embodiments of the invention, the monitor may respond by, for example, changing the instance status to “Red” for a system that uses color codes for status; by sending alerts to a human operator; or by sending a message to the software instance so that the software instance can take any predefined actions.

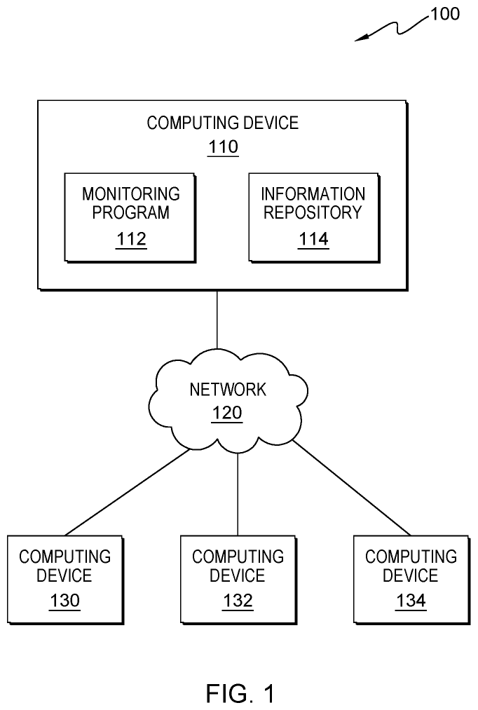

FIG. 1 is a functional block diagram illustrating a distributed data processing environment, generally designated 100, suitable for operation of monitoring program 112 in accordance with at least one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 110, computing device 130, computing device 132, and computing device 134, all connected to network 120. Network 120 can be, for example, a telecommunications network, a local area network (LAN), a wide area network (WAN), such as the Internet, or a combination of the three, and can include wired, wireless, or fiber optic connections. Network 120 can include one or more wired and/or wireless networks that are capable of receiving and transmitting data, voice, and/or video signals, including multimedia signals that include voice, data, and video information. In general, network 120 can be any combination of connections and protocols that will support communications between computing device 110, computing device 130, computing device 132, computing device 134, and other computing devices (not shown) within distributed data processing environment 100.

Computing device 110, computing device 130, computing device 132, and computing device 134, can each be a standalone computing device, a management server, a web server, a mobile computing device, or any other electronic device or computing system capable of receiving, sending, and processing data. In an embodiment, computing device 110, computing device 130, computing device 132, and computing device 134, can each be a laptop computer, a tablet computer, a netbook computer, a personal computer (PC), a desktop computer, a personal digital assistant (PDA), a smart phone, or any programmable electronic device capable of communicating with other computing devices (not shown) within distributed data processing environment 100 via network 120. In another embodiment, computing device 110, computing device 130, computing device 132, and computing device 134, can each represent a server computing system utilizing multiple computers as a server system, such as in a cloud computing environment. In yet another embodiment, computing device 110, computing device 130, computing device 132, and computing device 134, each represents a computing system utilizing clustered computers and components (e.g., database server computers, application server computers, etc.) that act as a single pool of seamless resources when accessed within distributed data processing environment 100.

In an embodiment, computing device 110 includes monitoring program 112. In an embodiment, monitoring program 112 is a program, application, or subprogram of a larger program for monitoring production software to detect design deviations. In an alternative embodiment, monitoring program 112 may be located on any other device accessible by computing device 110 via network 120.

In an embodiment, computing device 130, computing device 132, and computing device 134 each run instances of the software application being monitored by monitoring program 112.

In an embodiment, computing device 110 includes information repository 114. In an embodiment, information repository 114 may be managed by monitoring program 112. In an alternate embodiment, information repository 114 may be managed by the operating system of the device, alone, or together with, monitoring program 112. Information repository 114 is a data repository that can store, gather, compare, and/or combine information. In some embodiments, information repository 114 is located externally to computing device 110 and accessed through a communication network, such as network 120. In some embodiments, information repository 114 is stored on computing device 110. In some embodiments, information repository 114 may reside on another computing device (not shown), provided that information repository 114 is accessible by computing device 110. Information repository 114 includes, but is not limited to, software design data, software operational data, monitor data, forensic data, operating system data, configuration data, and other data that is received by monitoring program 112 from one or more sources, and data that is created by monitoring program 112.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, a NoSQL database, an object-oriented database, or one or more files.

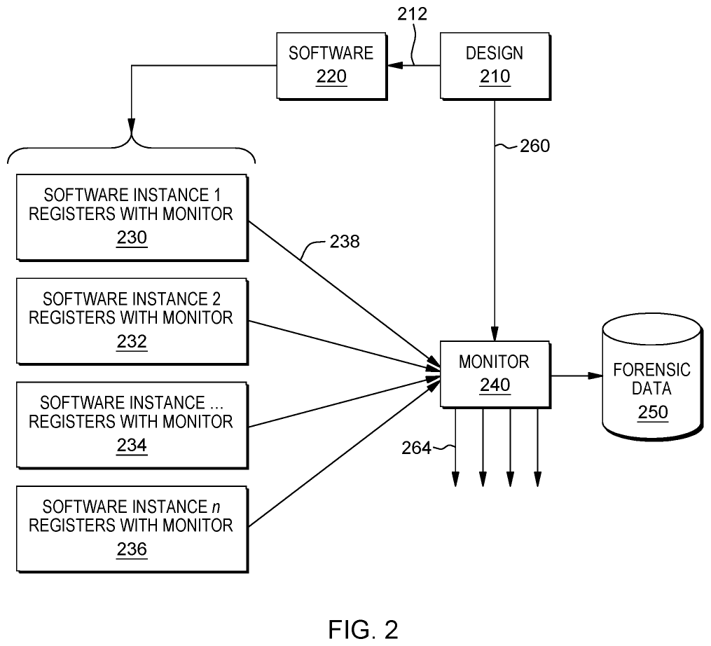

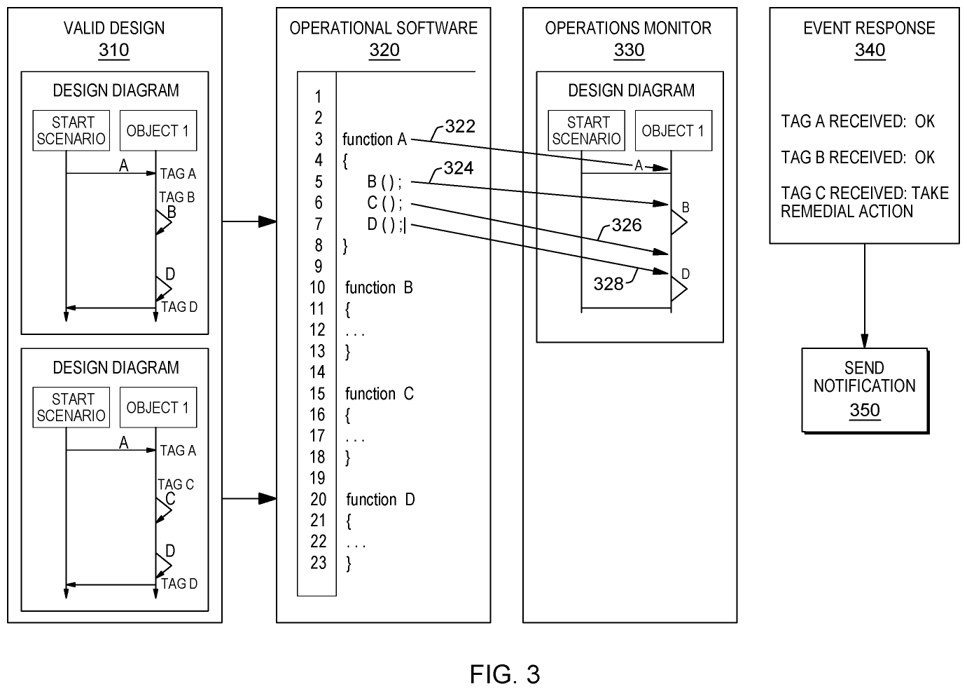

FIG. 2 is an example of the basic functionality of an embodiment of the present invention. Design 210 represents the design of the software that is to be monitored by monitoring program 112. This is accomplished using standard existing art software design tools. The output 212 of design 210 is used to generate the actual software 220. Actual software 220 is instrumented to send messages to monitor 240 that include actions performed by the instance. This is further explained in FIG. 3 below. In addition, design 210 sends actionable elements 260, to monitor 240. Monitor 240 is implemented by monitoring program 112. Actionable elements 260 are the design flows of the software design that are generated by the design tools used in design 210. Software instance 1 230, software instance 2 232, software instance 3 234, and software instance n 236, represent various instances of software 220 that have been deployed and executed. Each time an instance of software 220 is deployed and executes, the new instance registers with monitor 240, as shown in FIG. 2 by registration 238. For each instance of software 220 that is deployed and executes, monitor 240 creates a unique tracker, which are shown by trackers 264. In some embodiments, the tracking data is stored in forensic data 250, which can be used to analyze the particular instance of software 220 after a non-compliant behavior is detected by monitor 240.

It should be noted that this figure is provided for illustrative purposes only. Many modifications and variations will be apparent to those of ordinary skill in the art without departing from the scope and spirit of the invention.

FIG. 3 is an example of a detail view illustrating the steps for monitoring production software to detect design deviations, in accordance with an embodiment of the present invention. FIG. 3 includes valid design 310, which is created using existing art standard software design tools. Valid design 310 is one instance, either software instance 1 230, software instance 2 232, software instance 3 234, or software instance n 236 of design 210 from FIG. 2, showing more internal details. In valid design 310 there are four functions, which are implemented in operational software 320, which is a detail view of software 220 from FIG. 2. Operations monitor 330 is monitor 240 from FIG. 2, which is implemented by monitoring program 112. In this figure, messages 322, 324, 326, and 328 are sent from operational software 320 to operations monitor 330. In this example, each of these messages includes actions that have been taken by the instance of operational software 320, in this case that a new function has been called, based on the tags received from valid design 310. In an embodiment, other types of actions may include, but are not limited to, object creation, entry or exit of critical sections of code, sequence diagram call sequences, valid sequences of function calls, critical code sections, threads, and objects.

Operations monitor 330 compares the actions for the particular instance from operational software 320 to the actionable elements operations monitor 330 previously received from the software design, e.g., design 210 from FIG. 2. In this example, operations monitor receives tag A in message 322, which it determines is a valid action, and therefore the status is “ok.” Similarly, message 324 indicates a valid action, and therefore the status remains “ok.” But when operations monitor 330 receives message 326, it determines that the action is non-compliant, and therefore changes the status to “take remedial action.” Therefore, event response 340 sends a non-compliance notification, as denoted by send notification 350, depending on the configuration of the particular system. Various methods of notification are described below in the operation of monitoring program 112.

It should be noted that for any action received by monitor 330 there may be many possible sequences of valid actionable elements. In an embodiment, as long as there is any possible valid sequence, the status remains “ok”. Only when monitor 330 determines that there is no valid actionable element sequence based on the received action is the status changed to “take remedial action.”

In some embodiments, the designer of the software may also designate illegal sequences, i.e., sequences of actions that are, by definition, non-compliant. In an embodiment, if monitor 330 detects that the actions received from the executing instance constitute an illegal sequence, then the status is immediately changed to “take remedial action.”

It should be noted that this figure is provided for illustrative purposes only. Many modifications and variations will be apparent to those of ordinary skill in the art without departing from the scope and spirit of the invention.

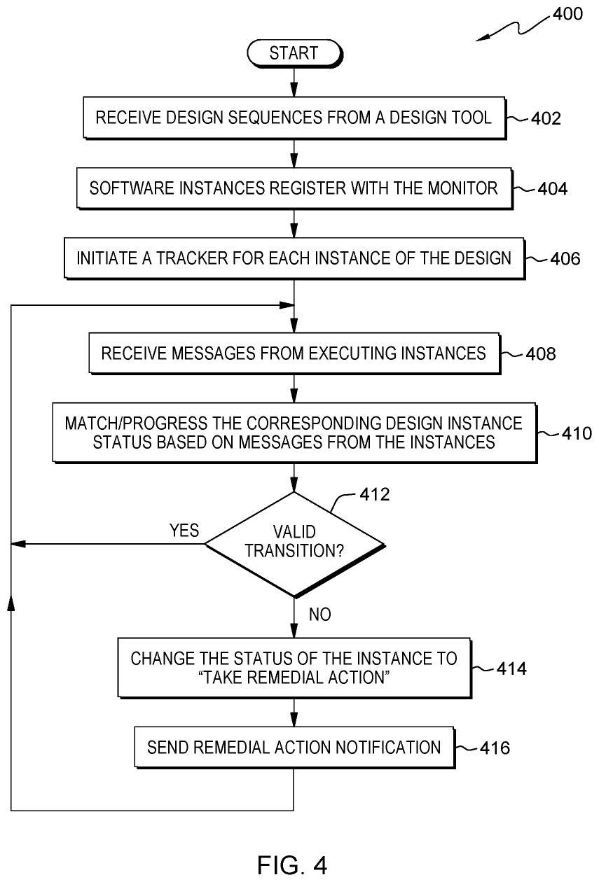

FIG. 4 is a flow chart diagram of workflow 400 depicting operational steps for monitoring program 112 for monitoring production software to detect design deviations in accordance with at least one embodiment of the invention. In an alternative embodiment, the steps of workflow 400 may be performed by any other program while working with monitoring program 112. In an embodiment, monitoring program 112 receives the design sequences from an existing art software design tool. In an embodiment, upon the deployment and execution of an instance of the software program, monitoring program 112 registers the instance by establishing an entry for the instance in the monitor function of monitoring program 112. In an embodiment, monitoring program 112 creates a unique tracker for each instance of the software that was registered in the previous step. In an embodiment, monitoring program 112 receives messages from the running instances of the software. In an embodiment, monitoring program 112 compares the messages received in a previous step from the instrumented software to the expected next events based on the design. In an embodiment, monitoring program 112 determines if the comparison of the messages to the design sequence indicates a valid transition. In an embodiment, when monitoring program 112 determines that an invalid transaction was detected in the previous step, then monitoring program 112 changes the status of that instance to “Take Remedial Action”. In an embodiment, monitoring program 112 sends a remedial action notification.

It should be appreciated that embodiments of the present invention provide at least for monitoring production software to detect design deviations. However, FIG. 4 provides only an illustration of one implementation and does not imply any limitations with regard to the environments in which different embodiments may be implemented. Many modifications to the depicted environment may be made by those skilled in the art without departing from the scope of the invention as recited by the claims.

Monitoring program 112 receives the actionable elements from a design tool (step 402). In an embodiment, monitoring program 112 receives the actionable elements from an existing art software design tool. In an embodiment, the actionable elements may include, but are not limited to, object creation, entry or exit of critical sections of code, sequence diagram call sequences, valid sequences of function calls, critical code sections, threads, and objects. In another embodiment, the actionable elements are any sequences that define the valid ordering of the execution of the code by the instances that can be used by monitoring program 112 to detect any instances where the ordering of the execution is not compliant with the software design.

Monitoring program 112 registers software instances with the monitor (step 404). In an embodiment, upon the deployment and execution of an instance of the software program, e.g., software instance 1 230, software instance 2 232, software instance 3 234, or software instance n 236 from FIG. 2, monitoring program 112 registers the instance by establishing an entry for the instance in the monitor function of monitoring program 112. In an embodiment, the entry may include, but is not limited to, the following message elements: GUIDs, the Media Access Control (MAC) address, Process ID (PID), and any other identifications that uniquely identify the particular invocation of the actionable elements. In an embodiment, the monitor returns a registration ID to the software instance that is registering. In an embodiment, the GUID identifies the particular, unique code element or actionable element in each software instance.

Monitoring program 112 initiates a tracker for each instance of the design (step 406). In an embodiment, monitoring program 112 creates a unique tracker for each instance of the software that was registered in step 404. In an embodiment, this tracker is initialized with the sequence of software state transitions from the design sequences received from the design tools in step 402.

Monitoring program 112 receives messages from executing instances (step 408). In an embodiment, monitoring program 112 receives messages from the running instances of the software. In an embodiment, the messages may contain, but are not limited to, a registration ID; a thread ID; a unique identifier for the code base that created the software; an object ID (self-pointer to the instance); the namespace for the instance; a time stamp; a sequence ID for the messages such that the monitor can determine if a message and sensor payload was lost, and the actual software state changes that occurred in the execution of that particular instance of the instrumented software application. In an embodiment, the messages contain the software state changes, or actions, that have occurred in the execution of the instances of the instrumented software application.

Monitoring program 112 matches/progresses the corresponding design instance status based on messages from the instances (step 410). In an embodiment, monitoring program 112 determines the particular instance from which the message was received. In an embodiment, monitoring program 112 determines the particular instance from which the message was received based on the message elements from step 404, including the GUID for that particular actionable element. In an embodiment, monitoring program 112 determines the particular instance from which the message was received from, for example, the registration ID sent in step 404. In an embodiment, monitoring program 112 then assigns that message to the unique tracker that was created for that instance. In an embodiment, monitoring program 112 then compares the messages received in step 408 from the instrumented software, e.g., software instance 1 230, software instance 2 232, software instance 3 234, or software instance n 236 from FIG. 2, to the expected next events based on the design, e.g., design 210 from FIG. 2. In an embodiment, monitoring program 112 determines the particular instance from which the message was received. In an embodiment, monitoring program 112 determines the particular instance from which the message was received based on the registration ID. In an embodiment, once monitoring program 112 determines the particular instance from which the message was received, monitoring program 112 adds the contents of the message, i.e., the software state changes, to the unique tracker that was created for that instance of the instrumented software application.

Monitoring program 112 determines if a transition is valid (decision block 412). In an embodiment, monitoring program 112 determines if the comparison of the messages to the design sequence indicates a valid transition. In some embodiments, the designer of the software designates illegal sequences, i.e., sequences of actions that are, by definition, non-compliant. In an embodiment, if monitor 330 detects that the actions received from the executing instance constitute an illegal sequence, then monitoring program 112 determines that the transitions are not valid. It should be noted that for any action received by monitoring program 112 there may be many possible sequences of valid actionable elements. In an embodiment, as long as there is any possible valid sequence, monitoring program 112, then monitoring program 112 determines that the transitions are valid. Only when monitoring program 112 determines that there is no valid actionable element sequence based on the received action does monitoring program 112 determine that the transitions are not valid.

In an embodiment, if monitoring program 112 determines that the transitions are valid (“yes” branch, decision block 412), then monitoring program 112 returns to step 408 to continue to monitor the messages from the running instances. In an embodiment, if monitoring program 112 determines that the transitions are not valid (“no” branch, decision block 412), then monitoring program 112 proceeds to step 414.

Monitoring program 112 changes the status of the instance to “Take Remedial Action” (step 414). In an embodiment, when monitoring program 112 determines that an invalid transaction was detected in decision block 412, then monitoring program 112 changes the status of that instance to “Take Remedial Action”. In an embodiment, monitoring program 112 uses a color code to indicate to a user the status of each running instance. In an embodiment, the color code that an instance is running properly is coded as green, and that an instance has detected an anomaly is coded as red. In an embodiment, if monitoring program 112 determines that the transitions are not valid, then monitoring program 112 changes the instance status to red.

Monitoring program 112 sends a remedial action notification (step 416). In an embodiment, monitoring program 112 sends a remedial action notification. In an embodiment, monitoring program 112 sends the alert to a system operator. In another embodiment, monitoring program 112 sends the alert to the running the instance of the software. In yet another embodiment, the alert is sent to any person that is set to receive such alerts in the system default policies. In an embodiment, monitoring program 112 then returns to step 408 to continue to monitor the messages from the running instances.

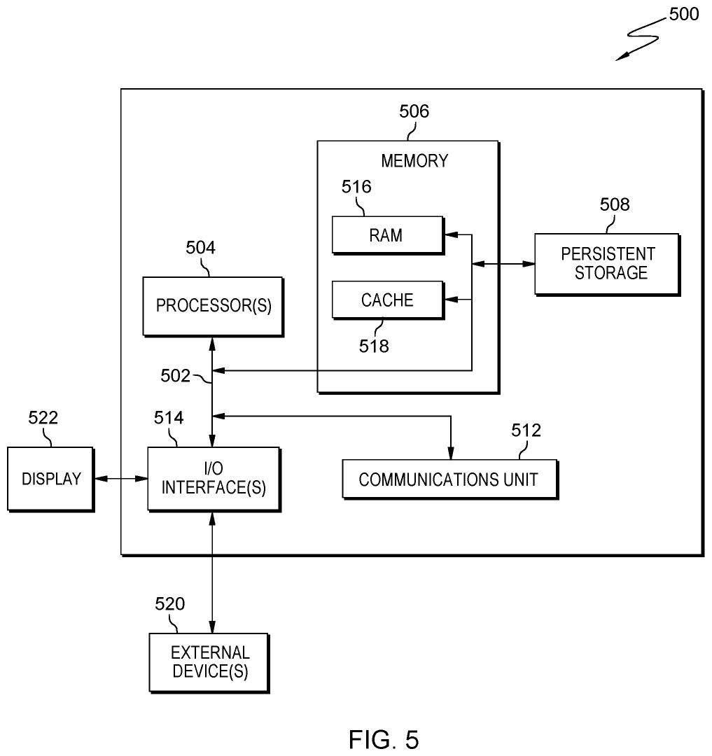

FIG. 5 is a block diagram depicting components of computing device 110 suitable for monitoring program 112, in accordance with at least one embodiment of the invention. FIG. 5 displays computer 500; one or more processor(s) 504 (including one or more computer processors); communications fabric 502; memory 506, including random-access memory (RAM) 516 and cache 518; persistent storage 508; communications unit 512; I/O interfaces 514; display 522; and external devices 520. It should be appreciated that FIG. 5 provides only an illustration of one embodiment and does not imply any limitations with regard to the environments in which different embodiments may be implemented. Many modifications to the depicted environment may be made.

As depicted, computer 500 operates over communications fabric 502, which provides communications between computer processor(s) 504, memory 506, persistent storage 508, communications unit 512, and I/O interface(s) 514. Communications fabric 502 may be implemented with any architecture suitable for passing data or control information between processors 504 (e.g., microprocessors, communications processors, and network processors), memory 506, external devices 520, and any other hardware components within a system. For example, communications fabric 502 may be implemented with one or more buses.

Memory 506 and persistent storage 508 are computer readable storage media. In the depicted embodiment, memory 506 comprises RAM 516 and cache 518. In general, memory 506 can include any suitable volatile or non-volatile computer readable storage media. Cache 518 is a fast memory that enhances the performance of processor(s) 504 by holding recently accessed data, and near recently accessed data, from RAM 516.

Program instructions for monitoring program 112 may be stored in persistent storage 508, or more generally, any computer readable storage media, for execution by one or more of the respective computer processors 504 via one or more memories of memory 506. Persistent storage 508 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 512, in these examples, provides for communications with other data processing systems or devices. In these examples, communications unit 512 includes one or more network interface cards. Communications unit 512 may provide communications through the use of either or both physical and wireless communications links. In the context of some embodiments of the present invention, the source of the various input data may be physically remote to computer 500 such that the input data may be received, and the output similarly transmitted via communications unit 512.

I/O interface(s) 514 allows for input and output of data with other devices that may be connected to computer 500. For example, I/O interface(s) 514 may provide a connection to external device(s) 520 such as a keyboard, a keypad, a touch screen, a microphone, a digital camera, and/or some other suitable input device. External device(s) 520 can also include portable computer readable storage media such as, for example, thumb drives, portable optical or magnetic disks, and memory cards. Software and data used to practice embodiments of the present invention, e.g., monitoring program 112, can be stored on such portable computer readable storage media and can be loaded onto persistent storage 508 via I/O interface(s) 514. I/O interface(s) 514 also connect to display 522.

Display 522 provides a mechanism to display data to a user and may be, for example, a computer monitor. Display 522 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for monitoring production software to detect design deviations, the computer-implemented method comprising:
receiving, by one or more computer processors, one or more actionable elements of an instrumented software application, wherein the one or more actionable elements are object creation in the instrumented software application;
monitoring, by the one or more computer processors, one or more actions performed by one or more instances of an instrumented software application, wherein the one or more instances of an instrumented software application are based on the software design;
comparing, by the one or more computer processors, the one or more actions to the one or more actionable elements; and
detecting, by the one or more computer processors, a non-compliant behavior, wherein the non-compliant behavior is a sequence of the one or more actions performed by any instance of the one or more instances of the instrumented software application that deviates from the one or more actionable elements.

2. The computer-implemented method of claim 1, wherein comparing the one or more actions to the one or more actionable elements further comprises:
receiving, by the one or more computer processors, one or more messages from the one or more instances of the instrumented software application, wherein the one or more messages are received for each software state change of a plurality of software state changes during the execution of the instrumented software application; and
comparing, by the one or more computer processors, the plurality of software state changes to the one or more actionable elements to detect the non-compliant behavior, wherein the non-compliant behavior is a sequence of the plurality of software state changes performed by the one or more instances of the instrumented software application that deviates from the one or more actionable elements.

3. The computer-implemented method of claim 1, wherein receiving the one or more actionable elements of the software design, wherein the one or more actionable elements are the one or more allowable actions of the software design further comprises:
registering, by the one or more computer processors, each instance of the one or more instances of the instrumented software application, wherein registering each instance of the one or more instances of the instrumented software application includes establishing an entry for each instance of the one or more instances of the instrumented software application in a monitor; and
initiating, by the one or more computer processors, a unique tracker in the monitor for each instance of the one or more instances of the instrumented software application, wherein the unique tracker monitors the one or more actions for a particular instance of the one or more instances of the instrumented software application.

4. The computer-implemented method of claim 3, wherein initiating the unique tracker in the monitor for each instance of the one or more instances of the instrumented software application, wherein the unique tracker monitors the one or more actions for the particular instance of the one or more instances of the instrumented software application further comprises:
receiving, by the one or more computer processors, one or more messages from the one or more instances of the instrumented software application during the execution of the instrumented software application, wherein the one or more messages contain the one or more actions;
matching, by the one or more computer processors, the one or more actions to each instance of the one or more instances of the instrumented software application to determine a matching instance of the one or more instances of the instrumented software application, wherein the one or more actions are matched to the particular instance of the one or more instances of the instrumented software application based on a unique identification for each instance of the one or more instances of the instrumented software application; and
adding, by the one or more processors, the one or more actions to the unique tracker in the monitor for the matching instance of the one or more instances of the instrumented software application.

5. (canceled)

6. The computer-implemented method of claim 1, further comprising:
responsive to detecting the non-compliant behavior, performing, by the one or more computer processors, one or more remediations.

7. The computer-implemented method of claim 6, wherein the one or more remediations include at least one of changing an instance status to error, alerting a user, and sending a message to the instance of the one or more instances of the instrumented software application.

8. A computer program product for monitoring production software to detect design deviations, the computer program product comprising:
one or more computer readable storage medium and program instructions stored on the one or more computer readable storage medium, the stored program instructions comprising instructions to:
receive one or more actionable elements of an instrumented software application, wherein the one or more actionable elements are object creation in the instrumented software application;
monitor one or more actions performed by one or more instances of an instrumented software application, wherein the one or more instances of an instrumented software application are based on the software design;
compare the one or more actions to the one or more actionable elements; and
detect a non-compliant behavior, wherein the non-compliant behavior is a sequence of the one or more actions performed by any instance of the one or more instances of the instrumented software application that deviates from the one or more actionable elements.

9. The computer program product of claim 8, wherein compare the one or more actions to the one or more actionable elements further comprises one or more of the following program instructions, stored on the one or more computer readable storage media, to:
receive one or more messages from the one or more instances of the instrumented software application, wherein the one or more messages are received for each software state change of a plurality of software state changes during the execution of the instrumented software application; and
compare the plurality of software state changes to the one or more actionable elements to detect the non-compliant behavior, wherein the non-compliant behavior is a sequence of the plurality of software state changes performed by the one or more instances of the instrumented software application that deviates from the one or more actionable elements.

10. The computer program product of claim 8, wherein receive the one or more actionable elements of the software design, wherein the one or more actionable elements are the one or more allowable actions of the software design further comprises one or more of the following program instructions, stored on the one or more computer readable storage media, to:
register each instance of the one or more instances of the instrumented software application, wherein register each instance of the one or more instances of the instrumented software application includes establish an entry for each instance of the one or more instances of the instrumented software application in a monitor; and
initiate a unique tracker in the monitor for each instance of the one or more instances of the instrumented software application, wherein the unique tracker monitors the one or more software state changes for a particular instance of the one or more instances of the instrumented software application.

11. The computer program product of claim 10, wherein initiate the unique tracker in the monitor for each instance of the one or more instances of the instrumented software application, wherein the unique tracker monitors the one or more actions for the particular instance of the one or more instances of the instrumented software application further comprises one or more of the following program instructions, stored on the one or more computer readable storage media, to:
receive one or more messages from the one or more instances of the instrumented software application during the execution of the instrumented software application, wherein the one or more messages contain the one or more actions;
match the one or more actions to each instance of the one or more instances of the instrumented software application to determine a matching instance of the one or more instances of the instrumented software application, wherein the one or more actions are matched to the particular instance of the one or more instances of the instrumented software application based on a unique identification for each instance of the one or more instances of the instrumented software application; and
add the one or more actions to the unique tracker in the monitor for the matching instance of the one or more instances of the instrumented software application.

12. (canceled)

13. The computer program product of claim 8, further comprising:
responsive to detecting the non-compliant behavior, perform one or more remediations.

14. The computer program product of claim 13, wherein the one or more remediations include at least one of changing an instance status to error, alerting a user, and sending a message to the instance of the one or more instances of the instrumented software application.

15. A computer system for monitoring production software to detect design deviations, the computer system comprising:
one or more computer processors;
one or more computer readable storage media; and
program instructions stored on the one or more computer readable storage media for execution by at least one of the one or more computer processors, the stored program instructions comprising instructions to:
receive one or more actionable elements of an instrumented software application, wherein the one or more actionable elements are object creation in the instrumented software application;
monitor one or more actions performed by one or more instances of an instrumented software application, wherein the one or more instances of an instrumented software application are based on the software design;
compare the one or more actions to the one or more actionable elements; and
detect a non-compliant behavior, wherein the non-compliant behavior is a sequence of the one or more actions performed by any instance of the one or more instances of the instrumented software application that deviates from the one or more actionable elements.

16. The computer system of claim 15, wherein compare the one or more actions to the one or more actionable elements further comprises one or more of the following program instructions, stored on the one or more computer readable storage media, to:
receive one or more messages from the one or more instances of the instrumented software application, wherein the one or more messages are received for each software state change of a plurality of software state changes during the execution of the instrumented software application; and
compare the plurality of software state changes to the one or more actionable elements to detect the non-compliant behavior, wherein the non-compliant behavior is a sequence of the plurality of software state changes performed by the one or more instances of the instrumented software application that deviates from the one or more actionable elements.

17. The computer system of claim 15, wherein receive the one or more actionable elements of the software design, wherein the one or more actionable elements are the one or more allowable actions of the software design further comprises one or more of the following program instructions, stored on the one or more computer readable storage media, to:
register each instance of the one or more instances of the instrumented software application, wherein register each instance of the one or more instances of the instrumented software application includes establish an entry for each instance of the one or more instances of the instrumented software application in a monitor; and
initiate a unique tracker in the monitor for each instance of the one or more instances of the instrumented software application, wherein the unique tracker monitors the one or more software state changes for a particular instance of the one or more instances of the instrumented software application.

18. The computer system of claim 17, wherein initiate the unique tracker in the monitor for each instance of the one or more instances of the instrumented software application, wherein the unique tracker monitors the one or more actions for the particular instance of the one or more instances of the instrumented software application further comprises one or more of the following program instructions, stored on the one or more computer readable storage media, to:
receive one or more messages from the one or more instances of the instrumented software application during the execution of the instrumented software application, wherein the one or more messages contain the one or more actions;
match the one or more actions to each instance of the one or more instances of the instrumented software application to determine a matching instance of the one or more instances of the instrumented software application, wherein the one or more actions are matched to the particular instance of the one or more instances of the instrumented software application based on a unique identification for each instance of the one or more instances of the instrumented software application; and
add the one or more actions to the unique tracker in the monitor for the matching instance of the one or more instances of the instrumented software application.

19. (canceled)

20. The computer system of claim 15, further comprising responsive to detecting the non-compliant behavior, perform one or more remediations.
